(19) United States
(12) Patent Application Publication
(10) Pub. No.: US 2013/0046833 A1
(43) Pub. Date: Feb. 21, 2013

(54) Method and System for Sending a Digital Invitation Requesting a Data Upload

(71) Applicants: Eric Casten Riepling, Soquel, CA (US); Reza Brian Vaziri, Corona, CA (US)

(72) Inventors: Eric Casten Riepling, Soquel, CA (US); Reza Brian Vaziri, Corona, CA (US)

(73) Assignee: SMITH MICRO SOFTWARE, INC., ALISO VIEJO (CA)

(21) Appl. No.: 13/211,146

(22) Filed: Aug. 16, 2011

(51) Int. Cl. G06F 15/16

(52) U.S. Cl. 709/206

(57) ABSTRACT

There is provided a method and system for sending, to a contact, a digital invitation requesting a data upload. There is provided a system comprising a server having a processor configured to receive the contact selected by a requester having a registered user account of a content sharing service, to transmit, to the contact, the digital invitation comprising a unique location identifier of the content sharing service, to receive a request to access the unique location identifier, to provide a file upload dialog associated with the registered user account and to receive a data upload in response to an uploading from the file upload dialog. Accordingly, an unregistered user of a content sharing service may upload a file to a registered user without registering a new account or obtaining the registered user login credentials.

### BACKGROUND OF THE INVENTION

1. Field of the Invention

The present invention relates generally to data sharing. More particularly, the present invention relates to digital invitations for data uploads.

2. Background Art

Internet-based content sharing services provide users with the ability to upload and share data such as documents, media files, and other content. By using these content sharing services, registered users may easily share data with other registered users on the same content sharing service. To protect users of a content sharing service from unsolicited messages, malware, and other threats, guest access from unregistered accounts may be limited or denied, preventing unregistered users from sending data uploads to registered users.

Thus, an unregistered user desiring to send a file through a content sharing service may be required to register a new user account, often a cumbersome and time consuming process. This may result in file upload delays, which may be problematic for time sensitive materials. Furthermore, unregistered users may have no interest in long-term usage of the content sharing service, thereby reducing the value and convenience proposition of user registration.

To avoid the issue of required registration, a registered user may provide the unregistered user direct access to the registered user account. However, this may require divulging private information such as login credentials to the unregistered user, which is highly undesirable from a security perspective.

Accordingly, there is a need to overcome the drawbacks and deficiencies in the art by providing a way for a registered user of a content sharing service to receive content from an unregistered user in a convenient and secure manner.

### SUMMARY OF THE INVENTION

There is provided methods and systems for sending, to a contact, a digital invitation requesting a data upload, substantially as shown in and/or described in connection with at least one of the figures, as set forth more completely in the claims.

### BRIEF DESCRIPTION OF THE DRAWINGS

The features and advantages of the present invention will become more readily apparent to those ordinarily skilled in the art after reviewing the following detailed description and accompanying drawings, wherein:

FIG. 1 presents a system for sending, to a contact, a digital invitation requesting a data upload, according to one embodiment of the present invention;

FIG. 2 presents a diagram of a request interface for selecting a contact to receive a digital invitation requesting a data upload, according to one embodiment of the present invention;

FIG. 3 presents a diagram of an upload parameter dialog for specifying upload parameters, according to one embodiment of the present invention;

FIG. 4 presents a diagram showing a digital invitation containing a unique location identifier, according to one embodiment of the present invention;

FIG. 5 presents a diagram of a file upload dialog for selecting data files for uploading, according to one embodiment of the present invention;

FIG. 6 presents a diagram of a dialog box associated with a revoked digital invitation, according to one embodiment of the present invention;

FIG. 7 presents a diagram of a data availability interface, according to one embodiment of the present invention; and

FIG. 8 shows a flowchart describing the steps, according to one embodiment of the present invention, by which a system for sending, to a contact, a digital invitation requesting an uploading of data may be accomplished.

### DETAILED DESCRIPTION OF THE INVENTION

The present application is directed to a method and system for sending, to a contact, a digital invitation requesting a data upload. The following description contains specific information pertaining to the implementation of the present invention. One skilled in the art will recognize that the present invention may be implemented in a manner different from that specifically discussed in the present application. Moreover, some of the specific details of the invention are not discussed in order not to obscure the invention. The specific details not described in the present application are within the knowledge of a person of ordinary skill in the art. The drawings in the present application and their accompanying detailed description are directed to merely exemplary embodiments of the invention. To maintain brevity, other embodiments of the invention, which use the principles of the present invention, are not specifically described in the present application and are not specifically illustrated by the present drawings.

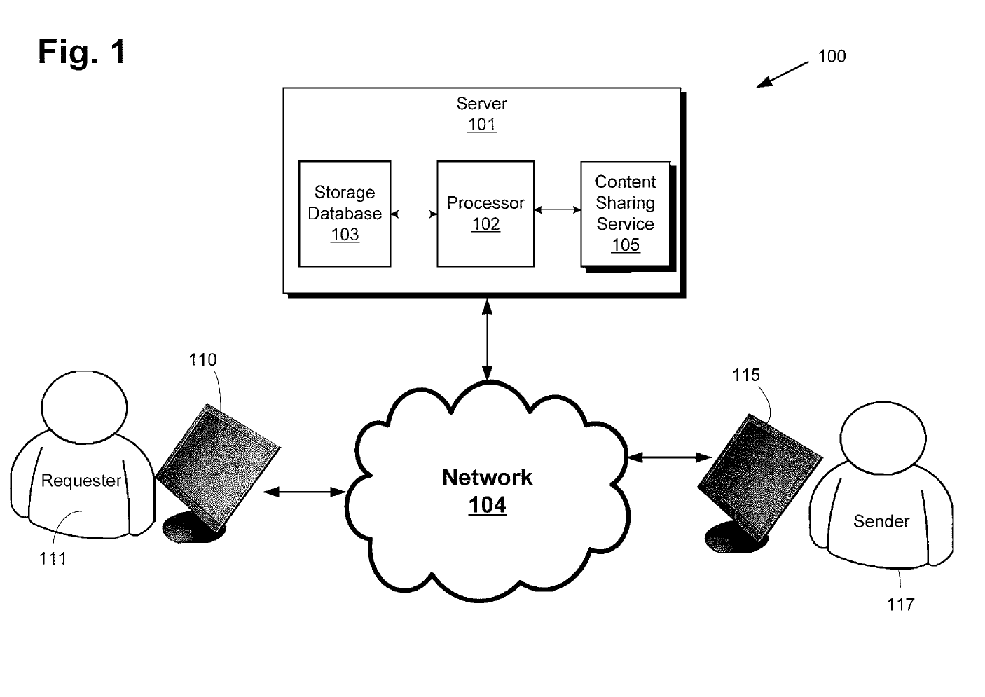

FIG. 1 presents a system for sending, to a contact, a digital invitation requesting a data upload, according to one embodiment of the present invention. System 100 of FIG. 1 includes server 101, network 104, request device 110, receive device 115, requester 111, and sender 117. Server 101 includes processor 102, storage database 103, and content sharing service 105.

Server 101 may comprise any type of computing server. Server 101 may be physically or wirelessly connected to network 104. Network 104 may comprise any public or private network such as the Internet or a local intranet. Processor 102 may comprise any type of server processor such as, for example, an Intel Xeon or Intel Itanium. Storage database 103 may comprise any type of storage medium capable of storing digital data. Content sharing service 105 may Content sharing service 105 may allow users to create user accounts that may receive data uploads from both registered users and non-registered users, as discussed below. Processor 102 may be used to execute content sharing service 105 and the processes required by content sharing service 105. Storage database 103 may be used to store any data generated from content sharing service 105.

Requester 111 may be any user who has created a registered user account within content sharing service 105. Requester 111, interacting with content sharing service 105 through request device 110, may attempt to send a digital invitation to another unregistered user using content sharing service 105. Request device 110 may comprise a personal computer (PC), a laptop, a tablet PC, a smartphone, or any other electronic device capable of connecting to network 104. Sender 117, who may be a user without a user account on content sharing service 105, may use receive device 115 to access any digital invitations transmitted to sender 117 from the registered user account of requester 111. Receive device 115, like request device 110, may comprise any electronic device, such as a PC, laptop, tablet PC, or any other device capable of connecting to network 104 and having an internal or externally connected display.

Using a registered user account on content sharing service 105, requester 111 may send a digital invitation to sender 117. A digital invitation may comprise an email message or any other type of textual and/or graphical message that may be delivered through network 104 to a contact associated with sender 117. A contact may comprise an email address or any other address information directing to a digital account capable of receiving digital invitations. Requester 111 may supply content sharing service 105 with many contacts.

Sender 117 may access a received digital invitation through receive device 115. As will be described below, a digital invitation may comprise instructions allowing sender 117, who may not have a user account on content sharing service 105, to gain the ability to perform a data upload into the registered user account of requester 111. Accordingly, FIG. 1 may show system 100 for sending, to a contact, a digital invitation requesting a data upload, wherein content sharing service 105 does not include a user account for a user corresponding to the contact.

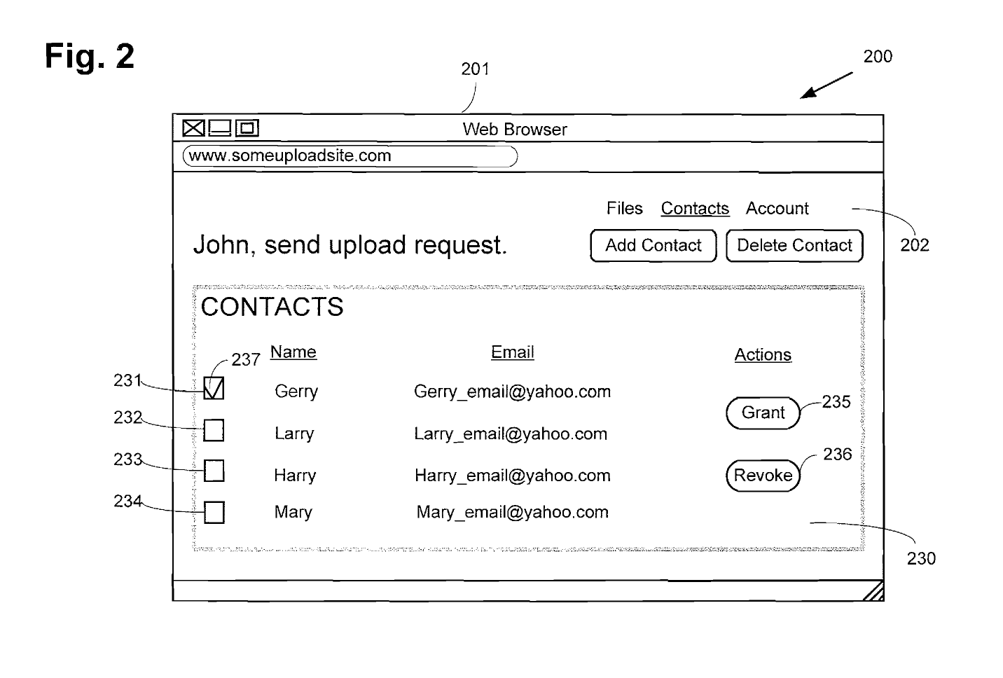

Proceeding to FIG. 2, FIG. 2 presents a diagram of a request interface for selecting a contact to receive a digital invitation requesting a data upload, according to one embodiment of the present invention. Diagram 200 of FIG. 2 includes web browser 201. Web browser 201 includes request interface 202. Request interface 202 includes list of contact information 230. List of contact information 230 includes selection boxes 231, 232, 233 and 234, grant access button 235, and revoke access button 236. Selection box 231 includes check mark 237 indicating selection box 231 is selected.

Web browser 201 may be any type of web browser including, for example, Mozilla Firefox, Microsoft Internet Explorer, or Google Chrome. Request interface 202 may be a graphical user interface (GUI) displaying within web browser 201. In turn, web browser 201 may be shown on the display of request device 110. Request interface 202 may show a section of the registered user account pertaining to the selection of a contact to receive a digital invitation. Request interface 202 may include list of contact information 230, which may include selection boxes 231-234. In an embodiment of the invention as shown in FIG. 2, each of selection boxes 231-234 may be associated with a contact, for example an e-mail address. For example, check box 231 may be associated with the contact “Geny_email@yahoo.com,” which may be an email address for a person named “Gerry.” In alternative embodiments of the invention, the contact may be any other type of destination address capable of receiving a digital invitation. In yet other embodiments of the invention, list of contact information 230 may contain any number of contacts while displaying only a subset of the contacts at once.

Any of selection boxes 231-234 may be selected to indicate a selection of a contact. In an embodiment of the invention shown in FIG. 2, the contact, “Gerry_email@yahoo.com,” may be selected by placing check mark 237 into selection box 231. By selecting “Gerry_email@yahoo.com,” the user has selected a contact to receive a digital invitation. In other instances of the embodiment, multiple contacts may be selected by selecting a combination of selection boxes from selection boxes 231-234. Grant access button 235 may be used to finalize the selection of the contact. Once grant access button 235 has been used, content sharing service 105, using processor 102, may begin creating a digital invitation for transmission to the contact.

After the selection of the contact, the registered user may also use revoke access button 236 instead of grant access button 235 to create a revocation of any digital invitations previously transmitted to the selected contact. In an embodiment of the invention shown in FIG. 2, using revoke access button 236 may cause content sharing service 105, using processor 102, to revoke all digital invitations sent to the contact, “Gerry_email@yahoo.com,” in response to receiving the revocation. As will be explained below, a revoked digital invitation will no longer allow a data upload.

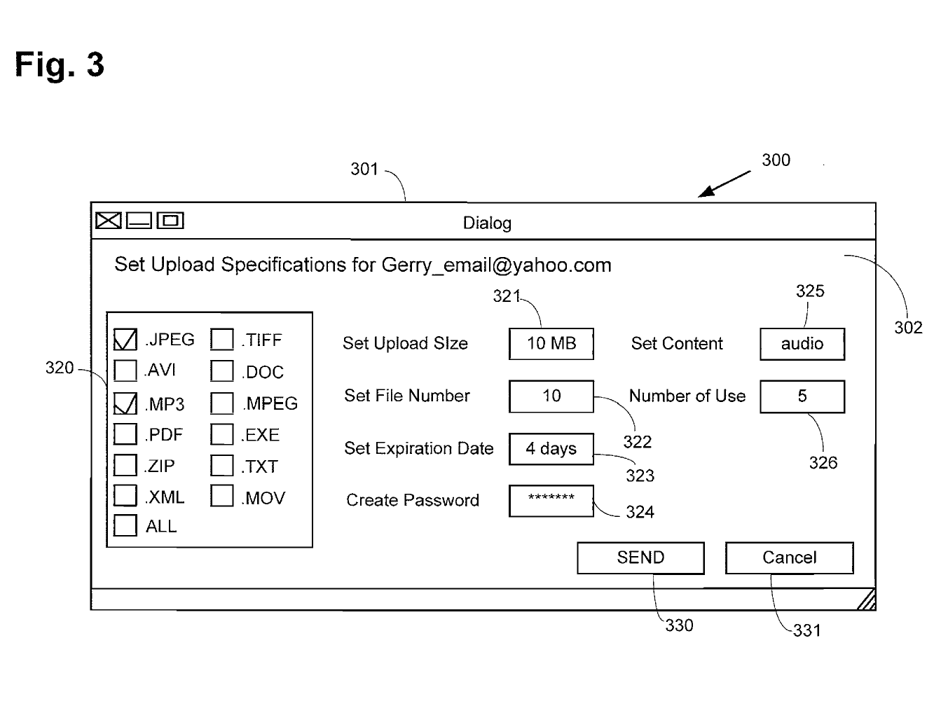

Moving to FIG. 3, FIG. 3 presents a diagram of an upload parameter dialog for specifying upload parameters, according to one embodiment of the present invention. Diagram 300 of FIG. 3 includes upload parameter dialog 301. In one embodiment, upload parameter dialog 301 includes upload parameter interface 302. Upload parameter interface 302 includes file format check boxes 320, size limit field 321, file number field 322, invitation expiration field 323, invitation password field 324, number of uses field 326, send button 330, and reset button 331. In some embodiments, upload parameters can be set differently for each contact.

Content sharing service 105 of FIG. 1, using processor 102 of FIG. 1, may further present upload parameter dialog 301 on a display in response to receiving a selection of one or more contacts. Upload parameter dialog 301 may be any type of dialog box. In alternative embodiments of the invention, upload parameter dialog 301 may also be shown within a browser. One or more upload parameters may be specified from upload parameter dialog 301, wherein the one or more upload parameters may restrict the type of data an unregistered user may upload into a registered user account using the digital invitation. In addition to restricting the type of data that may be uploaded, the one or more upload parameters specified may also impose other restrictions on the digital invitation.

In one embodiment of the invention as shown in FIG. 3, file format check boxes 320 may comprise a group of check boxes, with each check box associated with a unique file extension. Requester 111 may select from file format check boxes 320 any number of file extensions, thereby generating a file format limitation, which restricts the types of data files that may be uploaded through a digital invitation based upon the selected file extensions. For example, in FIG. 3, file extensions representing Joint Photographic Experts Group (JPEG) files or MPEG-1 or MPEG-2 Audio Layer III (MP3) files may be selected from file format check boxes 320 to create the upload parameters that comprise the file format limitation. By selecting JPEG and MP3 file extensions, an owner, such as requester 111, of the registered user account may be ensuring that an unregistered user, such as sender 117, may be restricted from uploading data files that do not have JPEG or MP3 file extensions into the registered user account. For example, files with the EXE extension may be blocked. In alternative embodiments of the invention, the same file format limitation may instead be interpreted as allowing a data upload of any data files that do not have JPEG or MP3 file extensions, in other words specifying exclusions rather than inclusions. In further embodiments of the invention, upload parameter dialog 301 may contains other tools to allow the user to limit the type of files that may be uploaded based upon file extensions.

Other upload parameters restricting the data upload based upon data composition may be specified from upload parameter dialog 301, as well. Size limit field 321 may be a text field used to specify an upload parameter comprising a size limit of the data upload. For example, the text “10 MB” may be entered into size limit field 321 to specify that the total size of all the data that may be uploaded using the digital invitation may not exceed ten (10) megabytes. File number field 322 may be a text field used to specify an upload parameter comprising the total number of data files that may be uploaded using the digital invitation. For example, the text “10” may be entered into file number field 322 to specify that at most only ten (10) files may be uploaded using the digital invitation.

In alternative embodiments of the invention as shown in FIG. 3, upload parameter interface 302 may further include functionalities allowing registered users to ensure that individual files uploaded into their registered user accounts contain only a single type of data. For example, it may be possible for audio files such as MP3 files to contain non-MP3 data, such as JPEG data embedded within the MP3 files. Upload parameter interface 302 may be further configured to ensure that only MP3 files without embedded non-MP3 data may be uploaded into the accounts. These functionalities may be applied to the uploading of any type of data files and may be used in conjunction with file format check boxes 320.

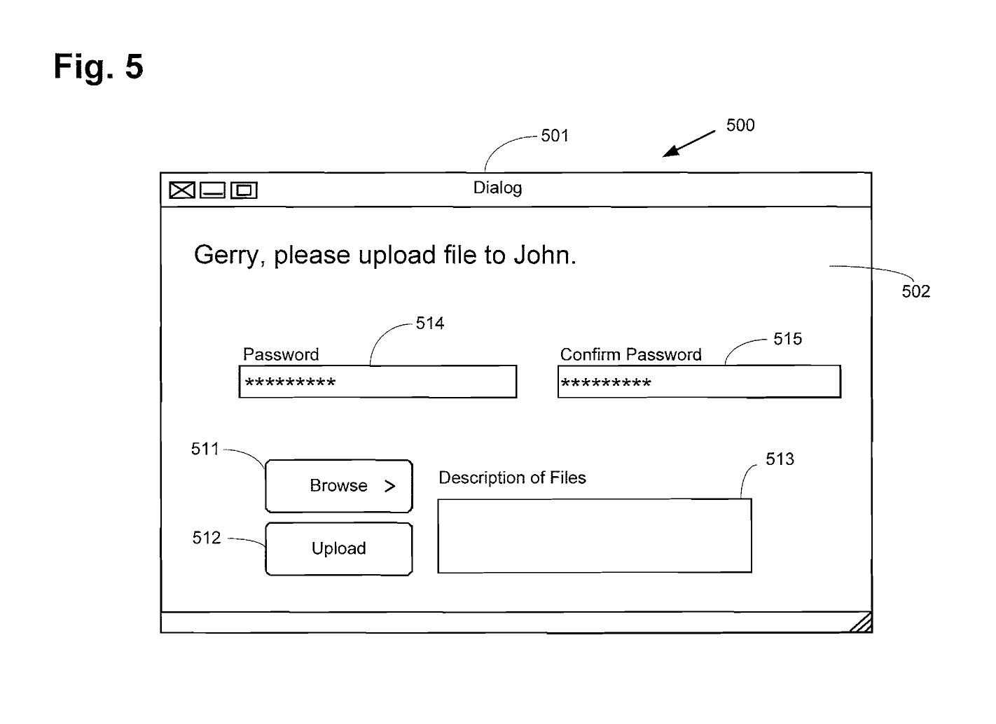

One or more upload parameters placing restrictions on the digital invitation may be specified in upload parameter dialog 301 as well. Invitation expiration field 323 may be a text field used to specify an upload parameter comprising a valid time window of a data upload associated with the digital invitation. For example, the text “4 days” or “4” may be entered into invitation expiration field 323 to specify that the digital invitation will be valid for four (4) days after it is sent to the contact. Alternatively, a specific time period, such as from Jun. 1, 2011, 8:00 am PST until Jun. 5, 2011, 8:00 am PST, may be provided. Invitation password field 324 may be a text field used to set a password that may be required in file upload dialog 501 of FIG. 5 in order for file upload dialog 501 to perform a data upload, as will be explained below. Number of use field 326 may be a text field used to specify the number of times a user may use the digital invitation for a data upload. For example, the text “5” may be entered into number of use field 326 to specify that a digital invitation may be used only five (5) times for uploading data into a registered user account. In alternative embodiments of the invention, additional upload parameters for restricting a digital invitation may be available.

Send button 330 may be used to send a digital invitation restricted by the one or more upload parameters specified in upload parameter dialog 301. Content sharing service 105, using processor 102, may transmit, to a contact, the digital invitation comprising a unique location identifier of content sharing service 105 of FIG. 1. The contents within a digital invitation and the unique location identifier shall be described in more detail below. Reset button 331 may be used to erase all upload parameters set in upload parameter dialog 301 so they may be reentered.

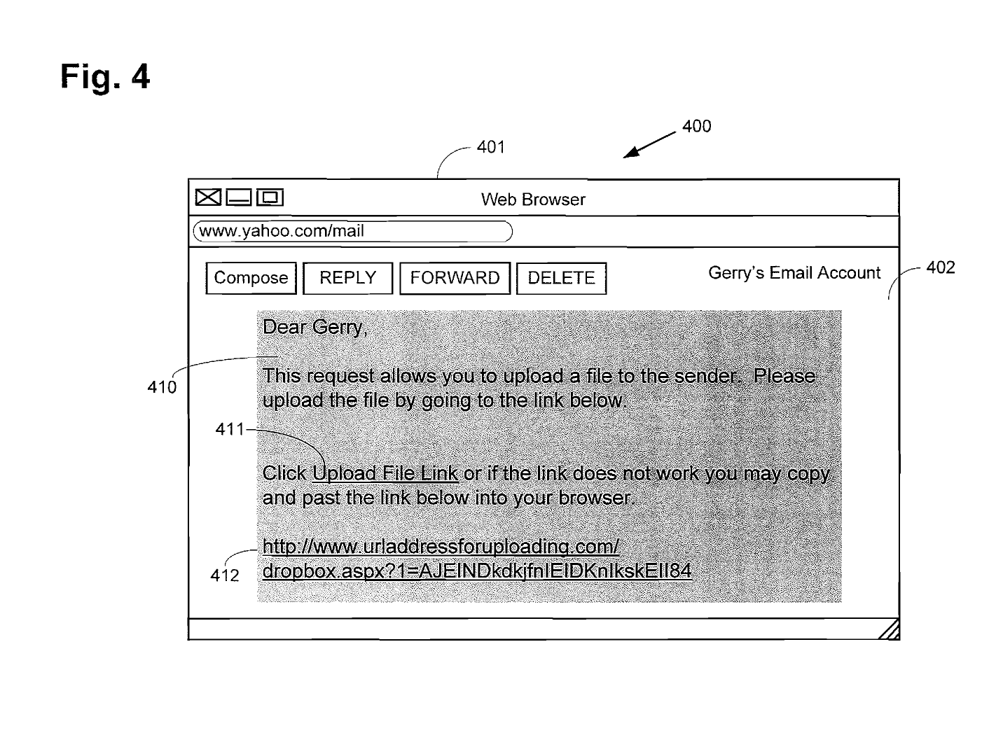

FIG. 4 presents a diagram showing a digital invitation containing a unique location identifier, according to one embodiment of the present invention. Diagram 400 of FIG. 4 includes web browser 401. Web browser 401 includes email interface 402. Email interface 402 includes digital invitation 410. Digital invitation 410 includes unique location identifiers 411 and 412 of content sharing service 105 of FIG. 1.

Web browser 401 may be any type of web browser, as explained earlier, and may be shown on a display of receive device 115 from FIG. 1. Email interface 402 may be the GUI for an email service program such as Microsoft Outlook Express or Google Gmail, for example. As explained previously, digital invitation 410 may be a textual email message. Digital invitation 410 may include unique location identifiers 411 and 412. Unique location identifier 411 may be a clickable textual link that may be presented as a set of keywords masking a destination web address. Unique location identifier 412 may display an actual destination web address. Both unique location identifiers 411 and 412 in FIG. 4 may link to the same web destination address.

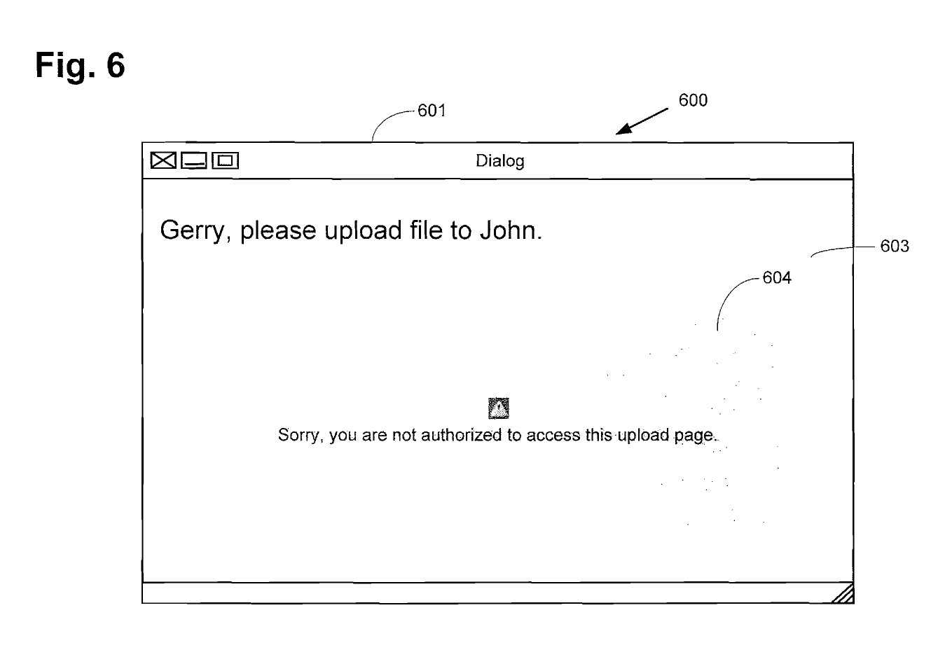

A user such as sender 117 in FIG. 1 may use receive device 115 to click on either of unique location identifiers 411 and 412, in which instance content sharing service 105 of FIG. 1, using processor 102 of FIG. 1, may receive a request to access the unique location identifiers 411 and 412. As a result of clicking on either of unique location identifiers 411 and 412, content sharing service 105, using processor 102, may direct web browser 401 to display another interface or launch another dialog associated with content sharing service 105. The outcome of clicking on unique location identifier 411 or 412 is further explained in conjunction with FIG. 5 and FIG. 6.

In an embodiment of the invention shown in FIG. 4, after receiving a request to access unique location identifier 411 or 412, content sharing service 105, using processor 102, may be further optionally configured to authenticate the contact. The contact, as explained earlier, may be an email address or any other destination address to a digital account. The authenticating of the contact may comprise verifying a relationship between the user associated with the contact and the registered user who sent digital invitation 410 to the contact. In an embodiment of the invention shown in FIG. 4, the relationship may comprise a simple online friendship. In alternative embodiments of the invention, a relationship may be defined as a professional business relationship, a kinship, or any other type of relationship, or establishing a relationship using the digital invitation itself.

Verifying an online friendship, for example, may entail searching one or more external social networking databases for the existence of such a friendship. For example, a social networking site may be searched to determine if the digital profile of the person receiving the digital invitation and the digital profile of the user sending the digital invitation are connected through a friendship connection within that social networking database. Content sharing service 105 may request such profile information from the one or more social networking databases to verify the relationship. If such a relationship can be found within the social networking database, then the authentication may be considered successful. An external social networking database may comprise any social networking service such as, for example, Facebook, Twitter, MySpace, or LinkedIn. In alternative embodiments of the invention, content sharing service 105 may prompt profile information from the registered user transmitting digital invitation 410 and/or from the person receiving digital invitation 410.

Once the relationship, such as a friendship, has been successfully verified, content sharing service 105, using processor 102, may display file upload dialog 501 of FIG. 5. However, if the relationship cannot be verified, then processor 102 may display a message (not shown) explaining that file upload cannot continue. In alternative embodiments of the invention, verification failure may result in delivery of a message to the registered user account that transmitted digital invitation 410. Such a message may comprise information detailing the verification failure.

FIG. 5 presents a diagram of a file upload dialog for selecting data files for uploading, according to one embodiment of the present invention. Diagram 500 of FIG. 5 includes file upload dialog 501. File upload dialog 501 includes upload interface 502. Upload interface 502 includes password entry field 514, confirm password entry field 515, browse button 511, upload button 512, and file description text field 513.

As previously described, a file upload dialog such as file upload dialog 501 may be presented in response to content sharing service 105 of FIG. 1 receiving a request to access the unique location identifier within digital invitation 410. File upload dialog 501 may be any type of graphical dialog box. Upload interface 502 may be displayed within file upload dialog 501.

Browse button 511, which may be a graphical button, may be used to select one or more data files for uploading. Browse button 511 may function like a conventional file browsing and selection button, as is known in the art. File description text field 513 may be any type of text field. File description text field 513 may receive a textual description of the one or more data files chosen for uploading. Upload button 512 may be used to perform a data upload by uploading the selected files into the registered user account. Using upload button 512 to upload the one or more data files may cause content sharing service 105 of FIG. 1, using processor 102 of FIG. 1, to receive a data upload in response to an uploading from file upload dialog 501. Accordingly, processor 102 may store the uploaded data into the registered user account that transmitted the digital invitation.

In an embodiment of the invention as shown in FIG. 5, before a data upload may be successfully performed, a password may be required to be entered into password entry field 514 and confirm password entry field 515, both of which may be any type of text field. As previously described, a password may be generated by the user of a registered user account in upload parameter dialog 301 of FIG. 3. The password may, for example, be provided to sender 117 in advance. In yet other embodiments of the invention as shown in FIG. 5, a password may not be required at all and password entry for protecting the data upload 514 and confirm password entry field 515 may not be shown. Furthermore, while the above examples focus on situations where requester 111 may set a password, another set of password fields may be alternatively or additionally provided to allow sender 117 to set a password on the file upload, which requester 111 must then correctly verify.

In an embodiment of the invention as shown in FIG. 5, content sharing service 105, using processor 102, may notify one or more user accounts within content sharing service 105 in response to receiving a data upload in the registered user account. As explained earlier, a data upload may occur when upload button 512 may be used to upload one or more selected data files. In an embodiment of the invention, one or more user accounts may receive an alert message or any other type of notification message alerting the other accounts of the data upload. The owner of the registered user account may specify which other user accounts are to receive the notifications automatically or manually. The notification messages may permit the downloading of the uploaded data through the one or more user accounts.

Proceeding to FIG. 6, FIG. 6 presents a diagram of a dialog box associated with a revoked digital invitation, according to one embodiment of the present invention. Diagram 600 of FIG. 6 includes dialog 601. Dialog 601 includes blocked interface 603. Blocked interface 603 includes revocation message 604.

As previously described, digital invitations may be revoked. Moreover, as previously explained, some upload parameters may also place restrictions on the digital invitation. Blocked interface 603 may occur when a user such as, for example, sender 117 of FIG. 1 may attempt to access content sharing service 105 through a unique location identifier of a revoked digital invitation. Blocked interface 603 may display revocation message 604, which may be any type of textual message stating that access to content sharing service 105 may no longer be available.

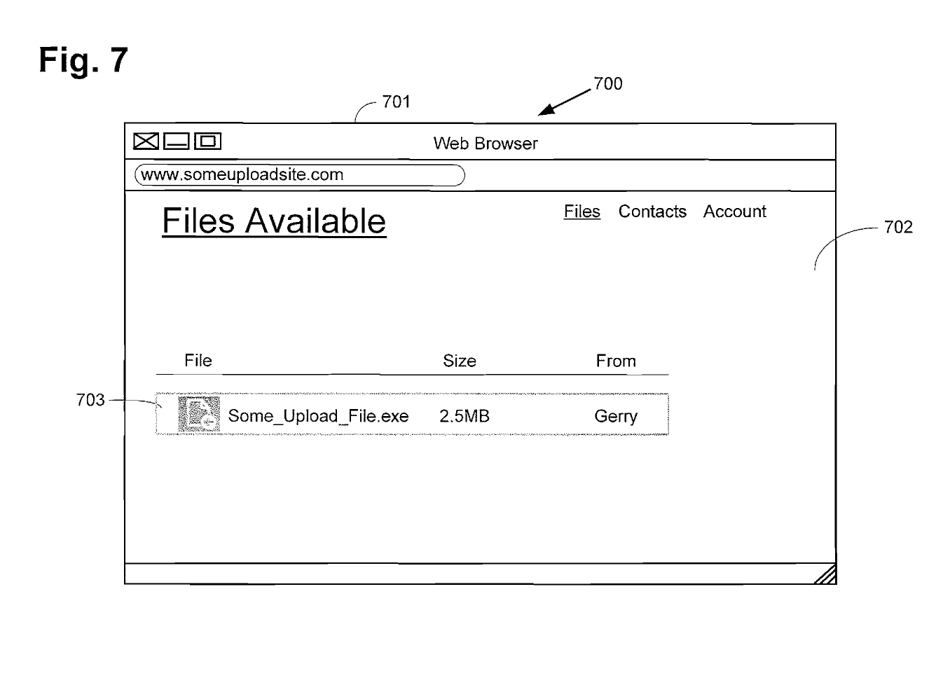

FIG. 7 presents a diagram of a data availability interface, according to one embodiment of the present invention. Diagram 700 of FIG. 7 includes web browser 701. Web browser 701 includes data availability interface 702. Data availability interface 702 includes file entry link 703.

Once a data upload has been successfully performed, the owner of the registered user account may view the uploaded data by accessing data availability interface 702, which may be shown on a display of request device 110. Data availability interface 702 may comprise a GUI. File entry link 703 may be a clickable link associated with the uploaded data. File entry link 703 may be used to open or download the actual data file associated with file entry link 703.

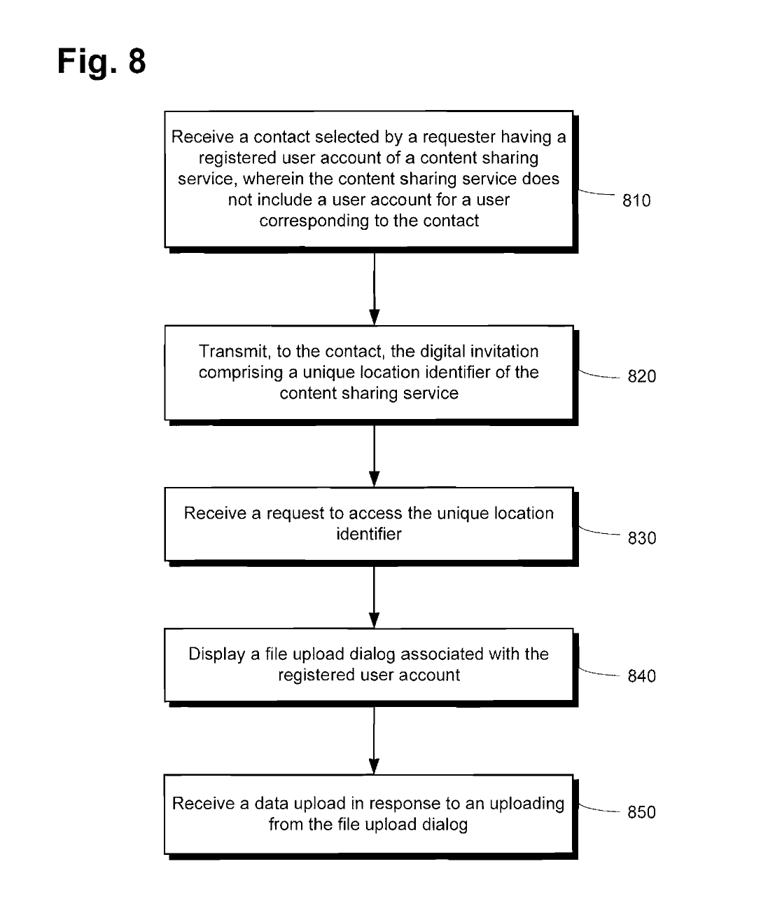

The system shown in FIG. 1 and the diagrams shown in FIGS. 2-7 will now be further described by additional reference to FIG. 8. FIG. 8 shows a flowchart describing the steps, according to one embodiment of the present invention, by which a system for sending, to a contact, a digital invitation requesting an uploading of data may be accomplished. Certain details and features have been left out of flowchart 800 that are apparent to a person of ordinary skill in the art. Thus, a step may comprise one or more sub-steps or may involve specialized equipment or materials, for example, as known the art. While steps 810 through 850 indicated in flowchart 800 are sufficient to describe one embodiment of the present method, other embodiments may utilize steps different from those shown in flowchart 800, or may include more, or fewer steps.

Referring to step 810 of flowchart 800 in FIG. 800 and referring to system 100 of FIG. 1, diagram 200 of FIG. 2 and diagram 400 of FIG. 4, step 810 comprises receiving a contact selected by requester 111 having a registered user account of content sharing service 105, wherein content sharing service 105 does not include a user account for a user corresponding to the contact. Requester 111, using request device 110, may access request interface 102 from the registered user account of the requester 111 in order to select a contact to receive digital invitation 410. Sender 117 may be a user corresponding to the contact. After selecting a contact from list of contact information 230, requester 111 may proceed to send, to the contact, digital invitation 410 by using grant access button 235.

Proceeding to step 820 of flowchart 800 in FIG. 800 and referring to system 100 of FIG. 1, diagram 300 of FIG. 3 and diagram 400 of FIG. 4, step 820 comprises transmitting, to a contact, digital invitation 410 comprising a unique location identifier of the content sharing service 105. After selection of a contact in step 810 is performed, content server 105, using processor 102, may further present upload parameter dialog 301 to allow requester 111 to specify and choose one or more upload parameters, which restrict the data selected for uploading based on content composition. As explained previously, the one or more upload parameters may also place restrictions on digital invitation 410. After completing selection of the one or more upload parameters, requester 111 may use send button 330 to send digital invitation 410, conforming to the one or more upload parameters, to the contact chosen in 810. The digital invitation 400 may be sent using e-mail or another means of communication.

Proceeding to step 830 of flowchart 800 in FIG. 800 and referring to system 100 of FIG. 1 and diagram 400 of FIG. 4, step 830 comprises receiving a request to access unique location identifier 411 and 412. After digital invitation 410 has been transmitted to the contact in step 830, sender 117, who may be the user associated with the contact, may now view digital invitation 410 on receive device 115. As explained previously, digital invitation 410 may contain unique location identifiers 411 and 412. Unique location identifiers 411 and 412 may represent a destination for performing the data uploads. Sender 117 may click on any of unique location identifiers 411 and 412 to cause content sharing service 105 to receive a request to access unique location identifiers 411 and 412.

Proceeding to step 840 of flowchart 800 in FIG. 800 and referring to system 100 of FIG. 1, diagram 400 of FIG. 4 and diagram 500 of FIG. 5, step 840 comprises displaying file upload dialog 501 associated with the registered user account. After content sharing service 105 receives a request to access unique location identifiers 411 and 412, content sharing service 105, using processor 102, may display, on a display of receive device 115, file upload dialog 501 associated with the registered user account. As explained previously, the functionalities of file upload dialog 501, such as determining which types of file to upload based on file extensions, may be restricted by the one or more upload parameters selected from step 820.

Proceeding to step 850 of flowchart 800 in FIG. 800 and referring to system 100 of FIG. 1, diagram 500 of FIG. 5 and diagram 700 of FIG. 7, step 850 comprises receiving a data upload in response to an uploading from file upload dialog 501. From file upload dialog 501 presented in step 840, sender 117 may elect one or more data files for uploading into the registered user account of requester 111. When a data upload may be performed, content sharing service 105, using processor 102, may receive the data upload in response to an uploading from file upload dialog 501. Once a data file has been successfully uploaded into the registered user account, the owner of the registered user account may access the data file through file entry link 703 displayed within data availability interface 702. File entry link 703 may function like a conventional clickable data link.

Thus, a system and method for sending a digital invitation requesting a data upload has been disclosed. Accordingly, unregistered users are enabled to upload files to registered users on content sharing services without the burdensome requirement of user registration and without compromising account security. Existing content sharing services can thus be more flexibly utilized for secure and convenient content sharing.

From the above description of the invention it is manifest that various techniques can be used for implementing the concepts of the present invention without departing from its scope. Moreover, while the invention has been described with specific reference to certain embodiments, a person of ordinary skills in the art would recognize that changes can be made in form and detail without departing from the spirit and the scope of the invention. As such, the described embodiments are to be considered in all respects as illustrative and not restrictive. It should also be understood that the invention is not limited to the particular embodiments described herein, but is capable of many rearrangement, modifications, and substitutions without departing from the scope of the invention.

What is claimed is:

1. A method for sending, to a contact, a digital invitation requesting an uploading of data, the method comprising:
receiving the contact selected by a requester having a registered user account of a content sharing service, wherein the content sharing service does not include a user account for a user corresponding to the contact;
transmitting, to the contact, the digital invitation comprising a unique location identifier of the content sharing service;
receiving a request to access the unique location identifier;
providing a file upload dialog associated with the registered user account;
receiving a data upload in response to an uploading from the file upload dialog.

2. The method of claim 1, further comprising revoking the digital invitation in response to receiving a revocation from the registered user account.

3. The method of claim 1, further comprising, prior to the displaying, authenticating the contact.

4. The method of claim 3, wherein the authenticating of the contact comprises verifying a relationship between the user and the requester using an external social networking database.

5. The method of claim 1, further comprising, prior to transmitting:
presenting an upload parameter dialog in response to receiving the selection;
receiving one or more upload parameters from the upload parameter dialog, wherein the one or more upload parameters restrict the data upload.

6. The method of claim 5, wherein the one or more upload parameters comprise a size limit of the data upload.

7. The method of claim 5, wherein the one or more upload parameters comprise a valid time window of the data upload.

8. The method of claim 1, wherein the file upload dialog includes a password entry for protecting the data upload.

9. The method of claim 5, wherein the one or more upload parameters comprise a file format limitation.

10. The method of claim 1, further comprising notifying one or more user accounts of the content sharing service in response to receiving the data upload.

11. A system for sending, to a contact, a digital invitation requesting an uploading of data, the system comprising:
a processor configured to:
receive the contact selected by a requester having a registered user account of a content sharing service, wherein the content sharing service does not include a user account for a user corresponding to the contact;
transmit, to the contact, the digital invitation comprising a unique location identifier of the content sharing service;
receive a request to access the unique location identifier;
provide a file upload dialog associated with the registered user account;
receive a data upload in response to an uploading from the file upload dialog.

12. The system of claim 11, wherein the processor is further configured to revoke the digital invitation in response to receiving a revocation from the registered user account.

13. The system of claim 11, wherein the processor, prior to the displaying, is further configured to authenticate the contact.

14. The system of claim 13, wherein the authenticating of the contact comprises verifying a relationship between the user and the requester using an external social networking database.

15. The system of claim 11, wherein the processor, prior to transmitting, is further configured to:
present an upload parameter dialog in response to receiving the selection;
receive one or more upload parameters from the upload parameter dialog, wherein the one or more upload parameters restrict the data upload.

16. The system of claim 15, wherein the one or more upload parameters comprise a size limit of the data upload.

17. The system of claim 15, wherein the one or more upload parameters comprise a valid time window of the data upload.

18. The system of claim 11, wherein the file upload dialog includes a password entry for protecting the data upload.

19. The system of claim 15, wherein the one or more upload parameters comprise a file format limitation.

20. The system of claim 11, wherein the processor is further configured to notify one or more user accounts of the content sharing service in response to receiving the data upload.
